(19) United States
(12) Patent Application Publication
(10) Pub. No.: US 2016/0217413 A1
(43) Pub. Date: Jul. 28, 2016

(54) PROCESS SAFETY MANAGEMENT SYSTEM AND METHOD

(71) Applicant: PITSolutions, LLC, Willow Hill, IL (US)

(72) Inventors: Tim Coombes, Willow Hill, IL (US); Aaron King, Terre Haute, IN (US)

(21) Appl. No.: 15/004,726

(22) Filed: Jan. 22, 2016

Related U.S. Application Data
(60) Provisional application No. 62/106,278, filed on Jan. 22, 2015.

(51) Int. Cl. G06Q 10/06; G06Q 50/26; G06F 17/30; H04L 29/06; H04L 29/08

(52) U.S. Cl. CPC G06Q 10/063114; H04L 67/42; H04L 67/10; H04L 63/08; H04L 63/102; G06F 17/30336; G06Q 10/06316; G06Q 50/265

(57) ABSTRACT

According to embodiments of the present invention, a process safety management database stored on a server records procedure data structures which may be copied to create job data structures which define an activity or combination of activities that fall under the OSHA definition of “process.” A personnel member performing a step of a covered process under OSHA regulations may use a client application from a client computer to track the progress of those steps, which may be transmitted by a server application to client computers of other personnel members in real-time while each client computer is in a different location. Upon completion of each step of a covered process, the server application may record the job data structure in a fixed state in fulfillment of regulatory certification requirements.

### CROSS-REFERENCE TO RELATED APPLICATIONS

The present application claims the benefit of U.S. Provisional Patent Application No. 62/106,278, filed Jan. 22, 2015, the content of which is hereby incorporated by reference in its entirety.

### BACKGROUND OF THE INVENTION

The present invention generally relates to safety management. More particularly, the present invention relates to a system and method for process safety management.

In accordance with regulations promulgated by the U.S. Occupational Safety and Health Administration, process safety management refers to procedures designed to reduce the danger of activities in the process industries. “Process” as defined by OSHA refers to “any activity involving a highly hazardous chemical including any use, storage, manufacturing, handling, or the on-site movement of such chemicals, or combination of these activities.” Businesses engaged in processes covered by the process safety management regulations are held responsible for ensuring that employees understand and participate in the management of hazards presented by covered processes.

In particular, employers must create written instructions for safely conducting the activities in each covered process. These written instructions are compiled in the form of physically bound references which must be manually retrieved from storage and consulted prior to the performance of a covered process by personnel. Furthermore, employers must also create written records documenting whether the performance of a covered process by personnel was in accordance with these written instructions, as well as documenting any deviations from these written instructions. Compliance with OSHA regulations requires the storage of certified copies of such written records. Recordkeeping and certification must be undertaken by authorized personnel members, but when authorized personnel members are not in the same location as personnel members performing a covered process, determination of the performance and progress of a covered process requires ad-hoc systems of communication and coordination.

The process of communicating information about the performance and progress of a covered process among personnel in different locations, and the process of subsequently recording such information by personnel who may not have first-hand experience of the performance and progress of the covered process, are subject to shortcomings in accuracy and efficiency. There has not been a dedicated system or method directed to the communication and recordation of information about the performance of covered processes.

### BRIEF SUMMARY OF THE INVENTION

Embodiments of the present invention provide a process safety management system and methods for the use thereof. A process safety management system according to embodiments of the present invention includes at least one client computer in communication with a server over a communication network, a process safety management database stored on the server, and a server application hosted on the server. The client computer may be a computing device such as a portable computer. A client application may be stored on the client computer.

A process safety management database according to embodiments of the present invention may store a procedure data structure, which may in turn store data elements which define a procedure according to the OSHA definition of “process,” and may further include any number of section data structures, which may further include any number of step data structures which may each include a plurality of step data elements. A note data structure may be stored associated with a step data structure. A procedure revision data structure may be stored associated with a step data structure.

A process safety management database according to embodiments of the present invention may store a job data structure, which may in turn store data elements which define an activity or a combination of activities that fall under the OSHA definition of “process,” and may further include a copy of a procedure data structure. The job data structure may further include a job progress status element and the copy of a step data structure may further include a step progress status element.

Queries or commands initiated by a human operator from the client computer to the server may be transmitted by the client application to the server application. The server application then performs operations on the process safety management database in accordance with the queries or commands.

Activities or combinations of activities that fall under the OSHA definition of “process” may be performed by personnel members of a facility. Personnel members may be assigned administrator roles, scribe roles, and viewer roles. Each personnel member having a role assigned may receive a user account for the client application, associated with a level of access which is commensurate to a personnel member's role according to a role assignment scheme.

The client application provides a variety of user interfaces which provide controls with which a user may interact to input queries or commands. The client application may disallow personnel members from inputting particular types of queries or commands depending on the role assigned to each personnel member. Personnel members may interact with user interfaces of the client application to create, edit, and delete user accounts; create, edit, and delete procedure data structures; create, edit, and delete job data structures; create, edit, and delete section data structures; edit and delete step data structures; track completion time for performance of steps by personnel members; create, edit, and delete note data structures; and review procedure revisions.

Embodiments of the present invention provide a process safety management method. Personnel members having administrator, scribe, and viewer roles each access the server from a different client computer running the client application. The personnel member having the administrator role creates a job data structure containing a copy of a procedure data structure. The personnel member having a scribe role accesses the step data structures of a section data structure. Upon the performance of a step by one or more personnel members having a scribe role, the personnel member having a scribe role starts a timer to track the timing of the performance of that step, and the server application commands client applications running on each client computer to refresh a timer display. Upon the completion of the performance of that step, the personnel member having a scribe role stops the timer and the step data structure is marked as finished. The personnel member having a scribe role may optionally create note data structures recording observations of step performance deviations from descriptions stored in the corresponding step data structure. Upon the marking of each step data structure of a job data structure as finished, the job data structure is recorded in a fixed state wherein it cannot be further modified.

### BRIEF DESCRIPTION OF THE DRAWINGS

FIG. 1 illustrates a diagram of a process safety management system according to embodiments of the present invention.

FIG. 2 illustrates the contents of a process safety management database which may be stored on a server storage, according to embodiments of the present invention.

FIGS. 3A and 3B illustrate a user list interface and a user account edit user interface which a server application may transmit to the client computer according to embodiments of the present invention.

FIG. 4 illustrates a procedure list user interface which a server application may transmit to the client computer according to embodiments of the present invention.

FIG. 5 illustrates a procedure edit user interface which a server application may transmit to the client computer according to embodiments of the present invention.

FIGS. 6A and 6B illustrate a job list user interface which a server application may transmit to the client computer according to embodiments of the present invention.

FIG. 7 illustrates a sections list user interface which a server application may transmit to the client computer according to embodiments of the present invention.

FIGS. 8A and 8B illustrate a steps management user interface which a server application may transmit to the client computer according to embodiments of the present invention.

FIG. 9 illustrates a step editing user interface which a server application may transmit to the client computer according to embodiments of the present invention.

FIGS. 10A and 10B illustrate a job view user interface which a server application may transmit to the client computer according to embodiments of the present invention.

FIG. 11 illustrates a job step notes user interface which a server application may transmit to the client computer according to embodiments of the present invention.

FIG. 12 illustrates a procedure revisions user interface which a server application may transmit to the client computer according to embodiments of the present invention.

FIG. 13 illustrates a flow diagram of a process safety management method according to embodiments of the present invention.

### DETAILED DESCRIPTION OF THE INVENTION

One or more of the embodiments of the present invention provide a process safety management system and methods for the use thereof. Embodiments of the present invention may be operated in conjunction with a server connected to a communication network, and at least one computer connected to a communication network.

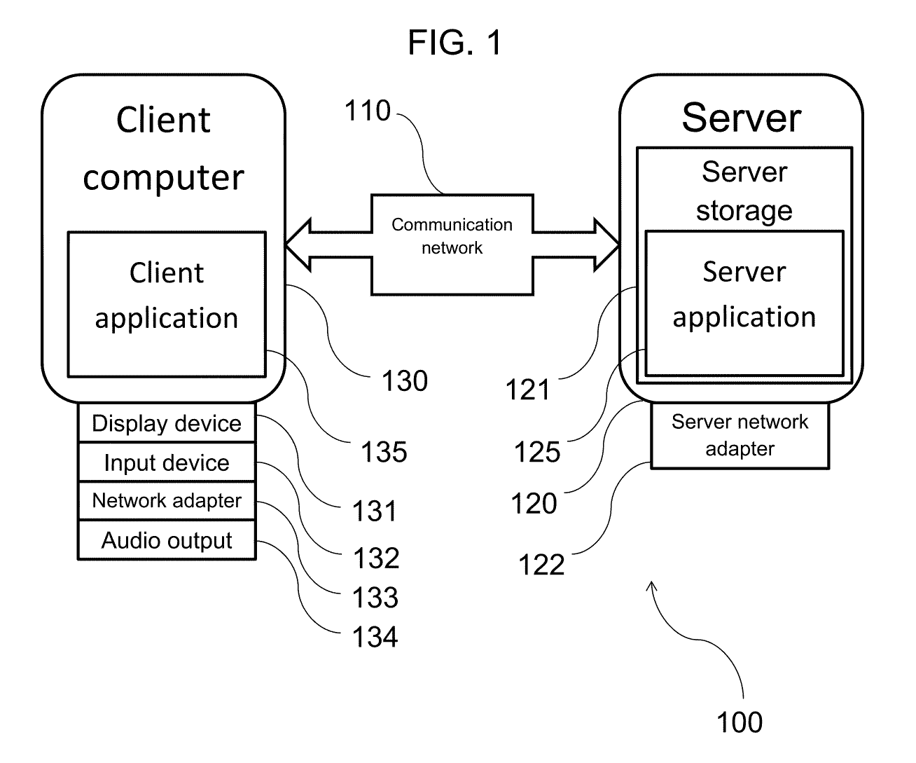

FIG. 1 illustrates a diagram of a process safety management system 100 according to embodiments of the present invention. The process safety management system 100 includes a communication network 110, a server 120, and at least one client computer 130 in communication with the server 120 over the communication network 110. A process safety management database 200 may be stored on a server 120.

The communication network 110 may be any global or local communication network that provides a communication protocol for computers and servers having network communication adapters. For example, the communication network 110 may be the Internet, a local area network, or other similar networks known to persons of ordinary skill in the art.

The server 120 may include a server storage 121 and a server network adapter 122. The server storage 121 may be any kind of electronic storage device suitable for recording databases, such as magnetic, solid-state, or other similar storage devices known to persons of ordinary skill in the art. The server network adapter 122 may be any hardware peripheral known to persons of ordinary skills in the art for communicating by a wired connection or a wireless connection between a device and a communication network 110.

A server application 125 may be hosted on the server 120. The server application 125 may write data to the server storage 121 and retrieve data from the server storage 121. The server application 125 may receive queries or commands from the client computer 130.

The client computer 130 may be a portable computer. For example, the client computer 130 may be a mobile smartphone, mobile tablet, or any of other mobile devices known to persons of ordinary skill in the art. The client computer 130 may be a laptop computer. The client computer 130 may be a desktop computer. The client computer 130 may be any among further computing devices known to persons of ordinary skill in the art.

The client computer 130 may include a display device 131, an input device 132, a network adapter 133, and an audio output 134. The display device 131 may be an optical device that displays an image for a human user, such as an LCD display or other similar displays known to persons of ordinary skill in the art. The input device 132 may be an input device for a mobile computer, such as a touch-sensitive screen incorporated into the display device, or a stylus pointing device for use with a touch-sensitive screen. The input device 132 may be an input device for a desktop or laptop computer, such as a keyboard or a mouse. The network adapter 133 may be any hardware peripheral known to persons of ordinary skills in the art for communicating by a wired connection or a wireless connection between a device and a communication network 110.

A client application 135 may be stored on the client computer 130. According to embodiments of the present invention, while a client computer 130 accesses the server 120, a server application 125 hosted on a server storage 121 may transmit a user interface to the client computer 130 for rendering in a client application 135. The client application 135 may render a user interface for display on the display device 131. The user interface may display data elements stored on the server 120. The input device 132 may be used by a human operator to input queries or commands through the client computer 130 to the server 120.

While a server application 125 transmits a user interface to the client computer 130, the server application 125 may refresh the display of the user interface so as to update data elements displayed on the user interface. A refresh of the display of the user interface may occur in real-time to indicate, for example, an update on the server 120 to data elements displayed on the user interface. More than one client computer 130 may access the server 120 simultaneously. While more than one client computer 130 is accessing the server, and while a server application transmits a user interface to each client computer 130 accessing the server, the server application 125 may refresh the display of the user interface for each client computer 130 so as to indicate an update on the server 120 to data elements displayed on each user interface.

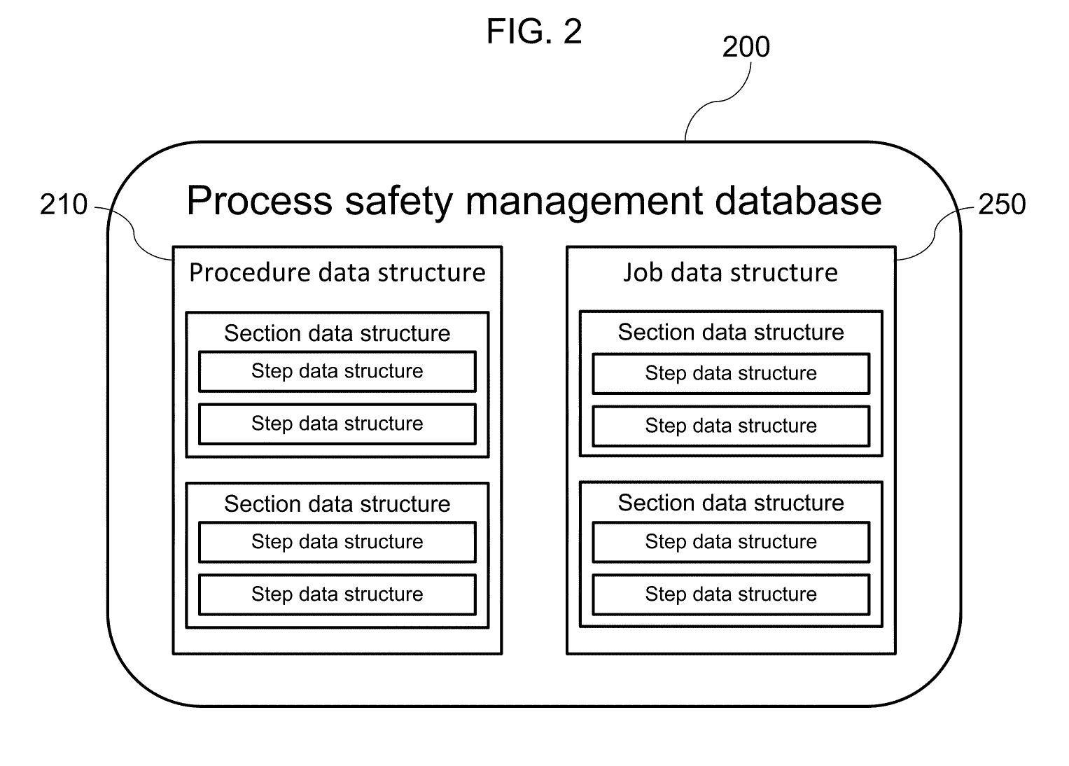

FIG. 2 illustrates the contents of a process safety management database 200 which may be stored on a server storage 121, according to embodiments of the present invention. A process safety management database 200 according to embodiments of the present invention may store a procedure data structure 210. A procedure data structure 210 may store data elements and data structures that define a procedure 300. A procedure 300 according to embodiments of the present invention may be an activity or a combination of activities that fall under the OSHA definition of “process.”

A procedure data structure 210 may include a plurality of procedure data elements. According to embodiments of the present invention, a procedure data element included in a procedure data structure 210 may be any of the following data elements:

A procedure title element;

A creator identifier element;

A creation time element;

A last updated time element;

A certification time element;

A version number element;

A document number element;

A purpose identifier element;

A scope identifier element;

A precautions identifier element;

A reference identifier element;

A definitions element.

A procedure data structure 210 may further include any number of section data structures. A section data structure according to embodiments of the present invention may include a section title element and a section number element.

A section data structure may further include any number of step data structures. A step data structure according to embodiments of the present invention may store data elements that define a step of a procedure. A step of a procedure according to embodiments of the present invention may be an activity among a combination of activities that fall under the OSHA definition of “process.”

A step data structure may include a plurality of step data elements. According to embodiments of the present invention, a step data element included in a step data structure may be any of the following data elements:

A step description element;

A step type element;

A timer enablement element;

A timer hours element;

A timer minutes element;

A start timestamp element;

A stop timestamp element;

A personnel initials element;

A step ordering element;

A step number element.

The type of a step data may be a step type, a note type, or a caution type. A step data structure of a note type or of a caution type may not have a timer enablement element, a timer hours element, a timer minutes element, a start timestamp element, and a stop timestamp element.

A step data structure may further include an image file. An image file may be stored in any image file format known by persons of ordinary skill in the art.

A process safety management database 200 according to embodiments of the present invention may, additionally, store a note data structure associated with a step data structure. According to embodiments of the present invention, a note data structure may include any of the following data elements:

A note contents element;

A note creator element;

A note creation date element.

A process safety management database 200 according to embodiments of the present invention may, additionally, store one or more procedure revision data structure associated with a step data structure. According to embodiments of the present invention, a procedure revision data structure may include any of the following data elements:

A version number element;

A pre-revision value element;

A post-revision value element;

A revision action element;

A revision date element;

A revision actor element.

A process safety management database 200 according to embodiments of the present invention may, additionally, store a job data structure 250. A job data structure 250 may store data elements and data structures that define a job 350. A job 350 according to embodiments of the present invention may be a single performance of an activity or a combination of activities that fall under the OSHA definition of “process.”

According to an embodiment of the present invention, a job data structure 250 may include a copy of a procedure data structure 210. A copy of a procedure title element of the procedure data structure 210 may be made as a job title element in the job data structure 250. A copy of a creation time element of the procedure data structure 210 may be made replacing the value of the creation time element with the time that the job data structure is created by copying the procedure data structure 210. The copy of a procedure data structure 210 may further include copies of the section data structures of the procedure data structure 210, and may further include copies of the step data structures of those section data structures.

A job data structure 250 according to embodiments of the present invention may further include a job progress status element. A copy of a step data structure according to embodiments of the present invention may further include a step progress status element. A job progress status element and a step progress status element may each have a status among several possible progress statuses. For example, a status may be a “not started” status, an “in progress” status, or a “finished” status. A job data structure 250 where the job progress status element has a “finished” status may be written in the process safety management database 200 in a fixed state where it cannot be further modified.

According to embodiments of the present invention, queries or commands initiated by a human operator from the client computer 130 to the server 120 may be received by the client application 135 and transmitted to the server application 125. The queries or commands may be interpreted by the server application 125, which may then perform operations on the process safety management database 200.

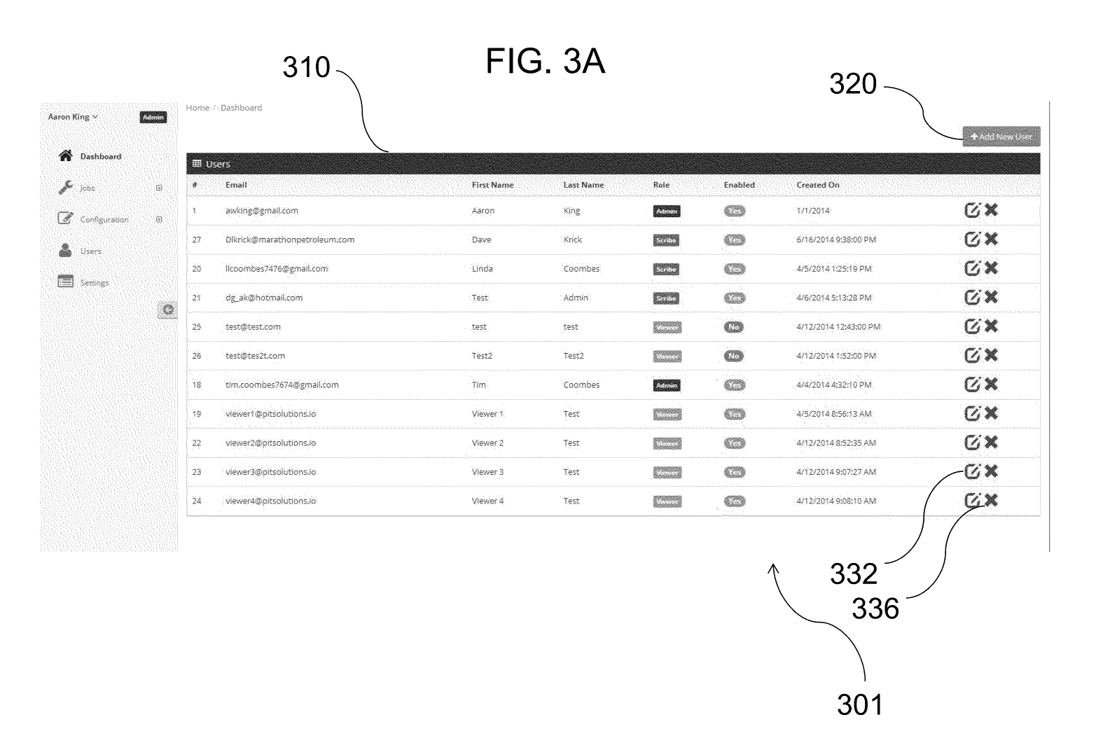

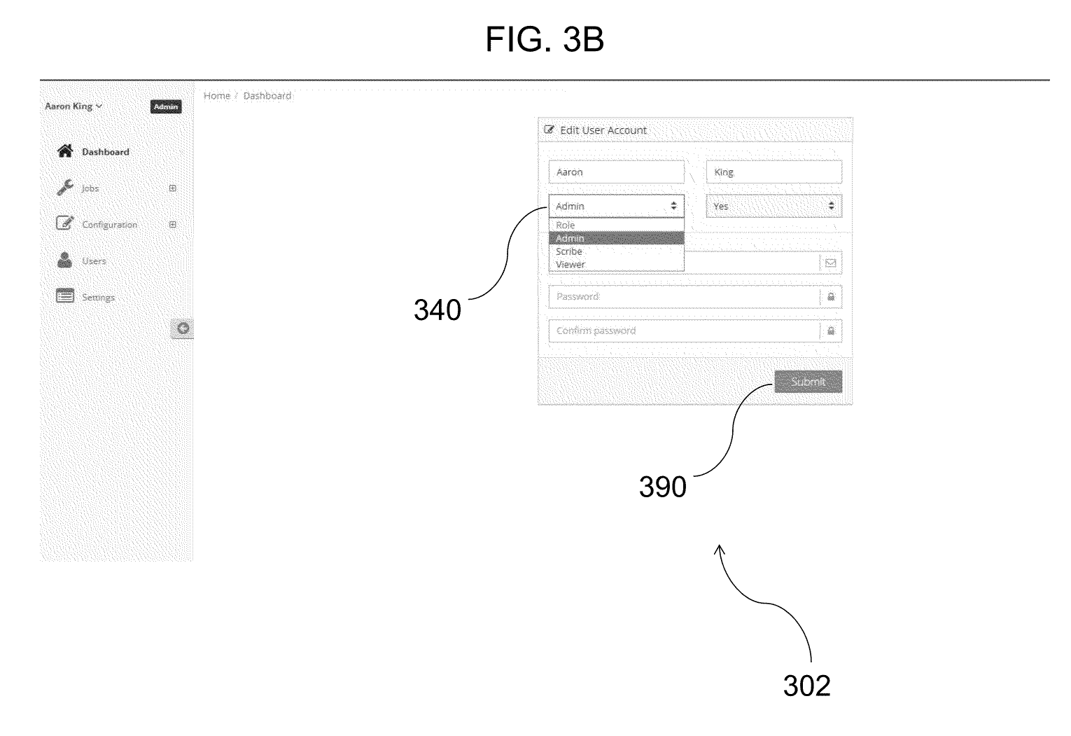

FIGS. 3A and 3B illustrate a user list interface 301 and a user account edit user interface 302 which a server application 125 may transmit to the client computer 130. The user list interface 301 includes a user list 310, a user creation control 320, an edit control 332, and a delete control 336.

According to embodiments of the present invention, activities or combinations of activities that fall under the OSHA definition of “process” may be performed by personnel members of a facility. In order to implement embodiments of the present invention, personnel members of the facility may be assigned roles which have particular relationships to systems and methods according to embodiments of the present invention. Roles assigned to personnel members of the facility may include, for example, an administrator role, a scribe role, and a viewer role.

An administrator role may be assigned to personnel members having a management relationship with regard to systems and methods of the present invention. Such personnel members may have management-level roles within the hierarchical structure of the facility, and may similarly be assigned to management roles with regard to systems of the present invention. Such personnel members may report to executive-level personnel members within the hierarchical structure of the facility.

A scribe role may be assigned to personnel members having high-level domain knowledge about procedures that are performed at a facility.

A viewer role may be assigned to any personnel members not meeting the above criteria, including supervisors, and managers who do not have management roles over systems of the present invention.

According to embodiments of the present invention, a personnel member having a role assigned may receive a user account for the client application 135. A user account may be stored in the process safety management database 200 and may be associated with a level of access which is commensurate to a personnel member's role according to a role assignment scheme. A personnel member may enter authentication credentials into the client application 135 using the input device 132 to identify the personnel member to the client application 135. Based on the level of access of the user account of the personnel member, the client application 135 may disallow particular types of queries or commands that the personnel member may input through the client computer 130 to the server 120. A type of query or command may be disallowed for a viewer role, or may be disallowed for a scribe role and a viewer role. More than one personnel member each having a role assigned may access the server 120 in this way from different client computers in locations remote from each other.

According to embodiments of the present invention, when a personnel member having an administrator role assigned is identified to the client application 135, the client application 135 may allow all types of queries or commands that the personnel member may input through the client computer 130.

According to embodiments of the present invention, when a personnel member having a scribe role assigned is identified to the client application 135, the client application 135 may disallow types of queries or commands that the personnel member may input through the client computer 130 which are disallowed for scribe roles and viewer roles. By way of example, such queries or commands may relate to creating procedures, editing procedures, reordering steps of procedures, and creating jobs.

According to embodiments of the present invention, when a personnel member having a viewer role assigned is identified to the client application 135, the client application 135 may disallow types of queries or commands that the personnel member may input through the client computer 130 which are disallowed for a scribe role and disallowed for a viewer role, as well as those types which are disallowed for a viewer role. By way of example, such queries or commands of the latter type may relate to setting progress statuses of steps of jobs.

A user list 310 may be a representation of each user account of a personnel member, and of the role assigned to each personnel member.

A personnel member may interact with a user creation control 320 to command the server application 125 to create a new user account in the process safety management database 200. This type of command may be disallowed for a scribe role and for a viewer role.

A personnel member may interact with an edit control 332 to select a user account represented in the user list 310 to request a user account edit user interface 302 to be transmitted to the client computer 130 displaying elements of the selected user account. This type of command may be disallowed for a scribe role and for a viewer role.

A personnel member may interact with a delete control 336 to select a user account represented in the user list 310 to command the server application 125 to delete the selected user account 210 from the process safety management database 200. This type of command may be disallowed for a scribe role and for a viewer role.

The user account edit user interface 302 includes several edit fields, which may include a role assignment control 340 and a submission control 390.

A personnel member may use the input device 120 to select a role from the role assignment control 340, and may use the submission control 390 to submit the selected role to the server application 125. The server application 125 may update the role of the user account in accordance.

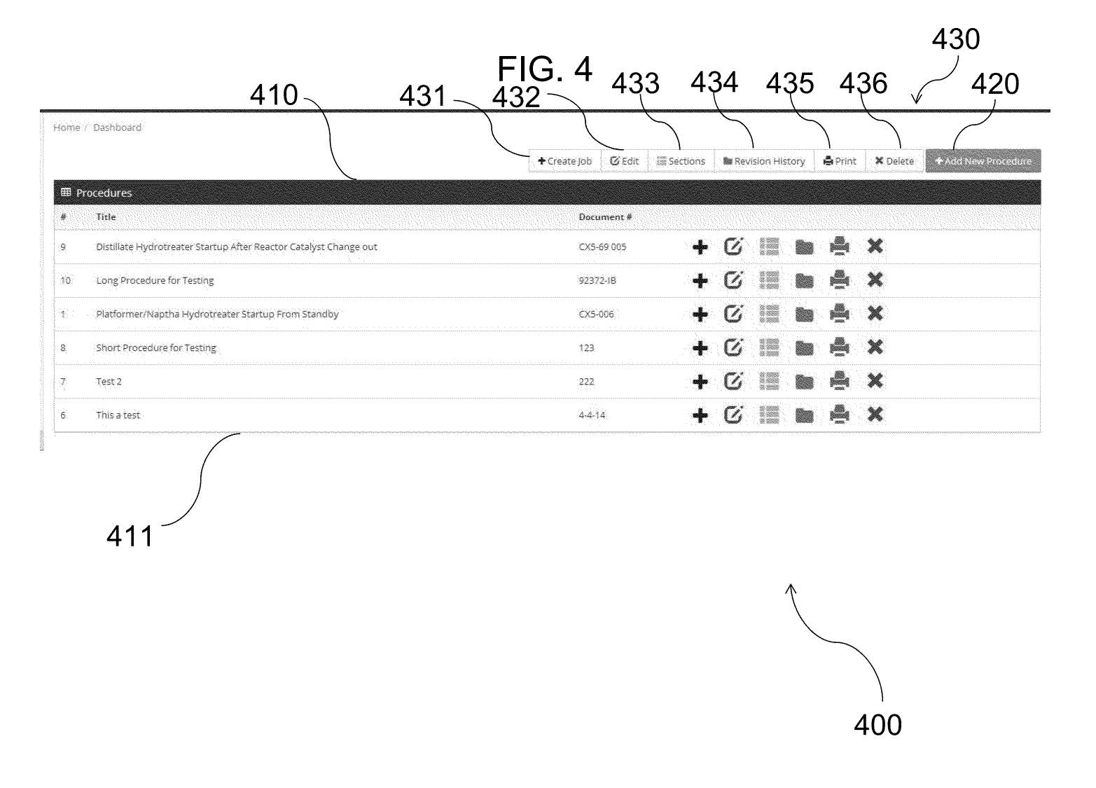

FIG. 4 illustrates a procedure list user interface 400 which a server application 125 may transmit to the client computer 130. The procedure list user interface 400 includes a procedure list 410, a procedure creation control 420, and a control panel 430, where the control panel 430 includes a job creation control 431, an edit control 432, a section control 433, a revision history control 434, a print control 435, and a delete control 436.

A procedure list 410 may be a representation of each procedure data structure 210 stored in a process safety management database 200. To represent each procedure data structure 210, a procedure list 410 may display a list item 411. A list item 411 may display the procedure title element and the document number element of the procedure data structure 210, and a copy of the control panel 430.

A personnel member may interact with a procedure creation control 420 to command the server application 125 to create a new procedure data structure 210 in the process safety management database 200, and to request a procedure edit user interface 500 to be transmitted to the client computer 130 displaying elements of the new procedure data structure 210. This type of command may be disallowed for a scribe role and for a viewer role.

When the server application 125 creates a new procedure data structure 210 in the process safety management database 200, it may create a procedure revision data structure associated with the creation of the new procedure data structure 210 in the process safety management database 200.

A personnel member may interact with a job creation control 431 to select a procedure data structure 210 represented in the procedure list 410 to command the server application 125 to create a new job data structure 250 containing a copy of the procedure data structure 210 in the process safety management database 200, and to request a job list user interface 600 to be transmitted to the client computer 130 displaying a list representing each job data structures 250 in the process safety management database 200. This type of command may be disallowed for a scribe role and for a viewer role.

A personnel member may interact with an edit control 432 to select a procedure data structure 210 represented in the procedure list 410 to request a procedure edit user interface 500 to be transmitted to the client computer 130 displaying elements of the selected procedure data structure 210. This type of command may be disallowed for a scribe role and for a viewer role.

A personnel member may interact with a section control 433 to select a procedure data structure 210 represented in the procedure list 410 to request a sections list user interface 700 to be transmitted to the client computer 130 displaying elements of the selected procedure data structure 210. This type of command may be disallowed for a scribe role and for a viewer role.

A personnel member may interact with a revision history control 434 to select a procedure data structure 210 represented in the procedure list 410 to request a procedure revisions user interface 1200 to be transmitted to the client computer 130 displaying a procedure revisions data structure corresponding to the procedure data structure 210. This type of command may be disallowed for a scribe role and for a viewer role.

A personnel member may interact with a print control 435 to select a procedure data structure 210 represented in the procedure list 410 to command the client computer 130 to transmit a command over the communication network 110 to a printer to print a copy of the select procedure data structure 210 represented in the procedure list 410.

A personnel member may interact with a delete control 436 to select a procedure data structure 210 represented in the procedure list 410 to command the server application 125 to delete the selected procedure data structure 210 from the process safety management database 200. This type of command may be disallowed for a scribe role and for a viewer role.

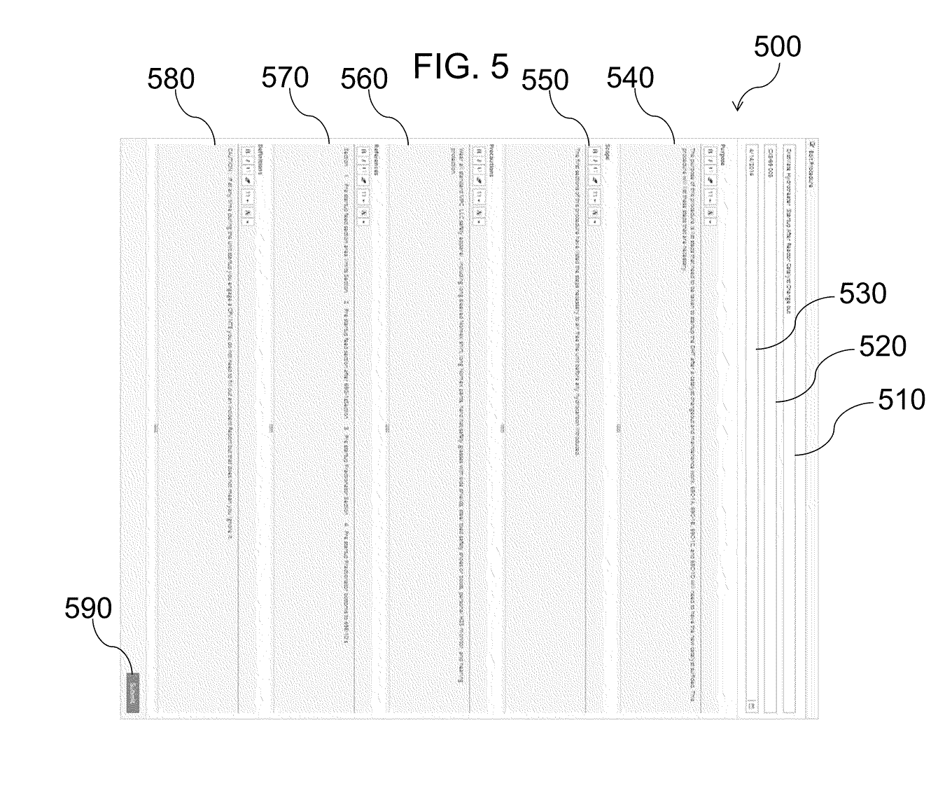

FIG. 5 illustrates a procedure edit user interface 500 which a server application 125 may transmit to the client computer 130. The procedure edit user interface 500 includes several edit fields, which may include a procedure title edit field 510, a document number edit field 520, a date edit field 530, a purpose edit field 540, a scope edit field 550, a precautions edit field 560, a references edit field 570, a definitions edit field 580, and a submission control 590.

The procedure edit user interface 500 may be transmitted to the client computer displaying elements of a procedure data structure 210. The procedure data structure 210 may be new. To render a procedure edit user interface 500, if the procedure data structure 210 is not new, the client application 135 may query data elements of the procedure data structure 210 from the process safety management database 200 and display each queried element in an edit field. The client application 135 may query a procedure title element and display it in a procedure title edit field 510. The client application 135 may query a document number element and display it in a document number edit field 520. The client application 135 may query a purpose identifier element and display it in a purpose edit field 540. The client application 135 may query a scope identifier title element and display it in a scope edit field 550. The client application 135 may query a precautions identifier element and display it in a precautions edit field 560. The client application 135 may query a references identifier element and display it in a references edit field 570. The client application 135 may query a definitions identifier element and display it in a definitions edit field 580.

A personnel member may use the input device 120 to input data into any, some, or all of the edit fields of the procedure edit user interface 500. Data entered into the purpose edit field 540, the scope edit field 550, the precautions edit field 560, the references edit field 570, and the definitions edit field 580 may provide information for a human reader regarding the performance of one or more steps of a procedure 300. For example, data entered into the purpose edit field 540 may describe one or more goals of performing a procedure 300. Data entered into the scope edit field 550 may describe context of one or more steps of a procedure 300. Data entered into the precautions edit field 560 may describe safety equipment to be used in performing one or more steps of a procedure 300. Data entered into the references edit field 560 may describe cross-references to one or more documents to be reviewed prior to performing one or more steps of a procedure 300. Data entered into the definitions edit field 570 may describe meanings of one or more terms used in any data elements of the procedure data structure 200 or in any documents cross-referenced by any data elements of the procedure data structure 200.

A personnel member may use the submission control 590 to submit data entered into the edit fields of the procedure edit user interface 500 to the server application 125. The server application 125 may update data elements of the procedure data structure 210 in accordance with corresponding data submitted from the edit fields of the procedure edit user interface 500.

When the server application 125 updates data elements of a procedure data structure 210 in the process safety management database 200, it may create a procedure revision data structure associated with the procedure data structure 210 in the process safety management database 200. The procedure revision data structure may have a version number element having a value one greater than the number of previously-created procedure revision data structures associated with the procedure data structure 210. The procedure revision data structure may have a pre-revision value element reflecting the values of the updated data elements prior to updating, and may have a post-revision value element reflecting the values of the updated data elements after editing. The procedure revision data structure may have a revision action element reflecting the type of update made to a data element, where the revision action element may have a value of “added” if a data element not previously present was added; the revision action element may have a value of “changed” if a data element previously present was changed; and the revision action element may have a value of “deleted” if a data element previously present was deleted. The procedure revision data structure may have a revision date element in accordance with the date of submission. The procedure revision data structure may have a revision actor element in accordance with the user account of the personnel member.

A procedure revision data structure may be retrieved from the server 120 as an electronic document. An electronic document may, for example, be a Portable Document Format file. An electronic document may be certified by an authorized personnel member in compliance with OSHA regulations.

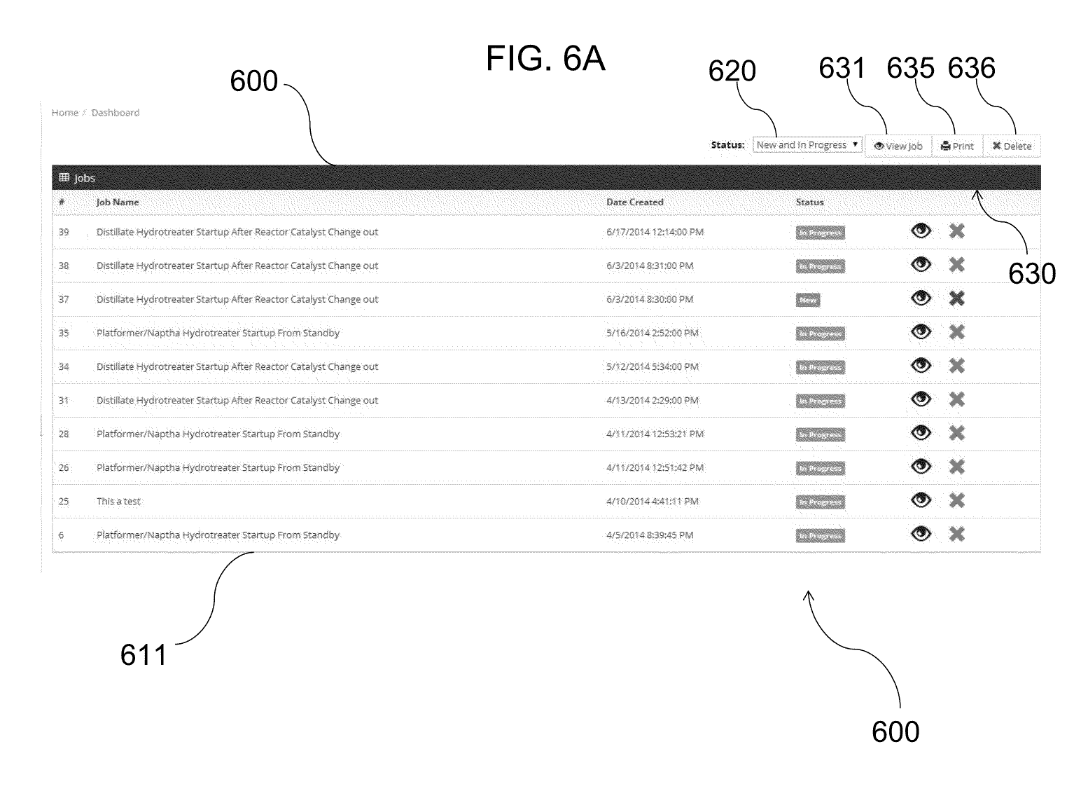

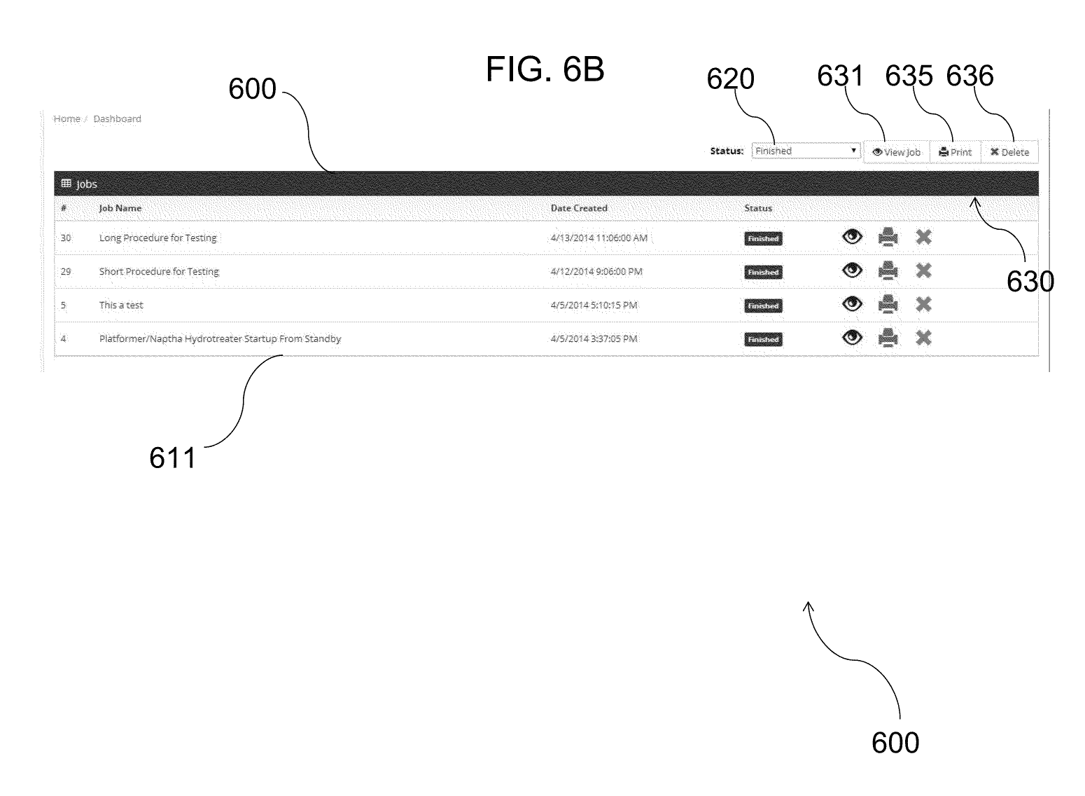

FIGS. 6A and 6B illustrate a job list user interface 600 which a server application 125 may transmit to the client computer 130. The job list user interface 600 includes a job list 610, a job status filter control 620, and a control panel 630, where the control panel 630 includes a job view control 631, a print control 635, and a delete control 636.

A job list 610 may be a representation of each job data structure 250 stored in a process safety management database 200. To represent each job data structure 250, a job list 610 may display a list item 611. A list item 611 may display the job title element and the creation time element of the job data structure 250, and a copy of the control panel 630.

A personnel member may interact with a job view control 631 to select a job data structure 250 represented in the job list 610 to command the server application 125 to request a section list user interface 700 to be transmitted to the client computer 130 displaying elements of the job data structure 250.

A personnel member may interact with a job progress status filter control 620 to select a status filter. The status filter may be a status among several possible progress statuses, such as a “not started” status, an “in progress” status, or a “finished” status. Selecting a status filter may command the server application 125 to query the process safety management database 200 for a status-filtered list of job data structures, containing each job data structure 250 having a job progress status element having a status that matches the status of the status filter. The server application 125 may further request a job list user interface 600 to be transmitted to the client computer displaying elements of the status-filtered list of job data structures. FIG. 6A illustrates a job list user interface 600 displaying elements of a status-filtered list of job data structures for the status filter of “not started” or “in progress.” FIG. 6B illustrates a job list user interface 600 displaying elements of a status-filtered list of job data structures for the status filter of “finished.”

A personnel member may interact with a print control 635 to select a job data structure 250 represented in the job list 610 to command the client computer 130 to transmit a command over the communication network 110 to a printer to print a copy of the selected job data structure 250 represented in the job list 610.

A personnel member may interact with a delete control 636 to select a job data structure 250 represented in the job list 610 to command the server application 125 delete the selected job data structure 250 from the process safety management database 200. This type of command may be disallowed for a scribe role and for a viewer role. Furthermore, this type of command may be disallowed for a job data structure 250 having a job progress status element with status “in progress” or with status “finished.”

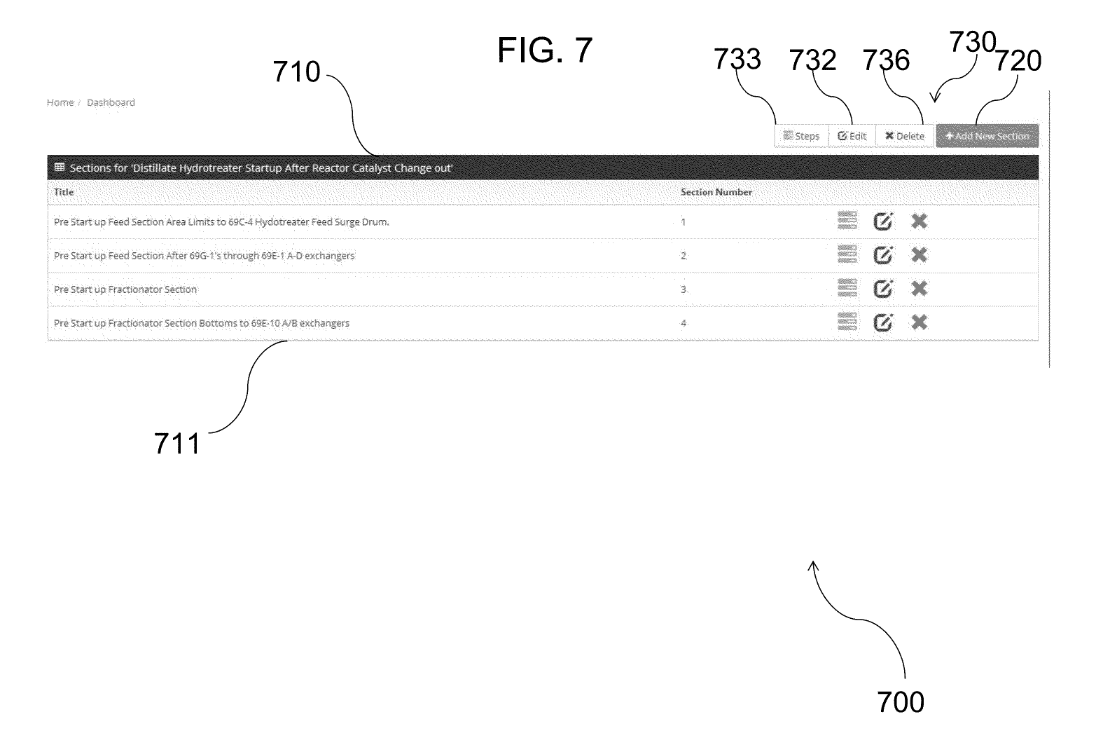

FIG. 7 illustrates a sections list user interface 700 which a server application 125 may transmit to the client computer 130. The sections list user interface 700 includes a sections list 710, a section creation control 720, and a control panel 730, where the control panel 730 includes a section edit control 732, a steps view control 733, and a delete control 736.

A sections list 710 may be a representation of each section data structure of a procedure data structure 210 or a job data structure 250 stored in a process safety management database 200. To represent each section data structure of a procedure data structure 210 or a job data structure 250, a job sections list 710 may display a list item 711. A list item 711 may display the section title element and the section number element of the section data structure, and a copy of the control panel 730.

A personnel member may interact with a section creation control 720 and input a section title to command the server application 125 to add a new section data structure to the procedure data structure 210 or the job data structure 250 stored in the process safety management database 200, and to request a sections list user interface 700 to be transmitted to the client computer 130 displaying an updated sections list 710 representing each section data structure of the procedure data structure 210 or the job data structure 250. The new section data structure may have a section title element section containing the section title input by the personnel member, and may have a section number element such that each section data structure in the procedure data structure 210 or the job data structure 250 has a unique section number element. This type of command may be disallowed for a scribe role and for a viewer role.

A personnel member may interact with a section edit control 732 to select a section data structure of the procedure data structure 210 or the job data structure 250 represented in the job sections list 710 to request a steps management user interface 800 to be transmitted to the client computer 130 displaying elements of the selected section data structure. This type of command may be disallowed for a scribe role and for a viewer role.

A personnel member may interact with a step control 733 to select a section data structure of the procedure data structure 210 or the job data structure 250 represented in the sections list 710 to request a steps tracking user interface 1000 to be transmitted to the client computer 130 displaying step data structures of the selected section data structure.

A personnel member may interact with a delete control 736 to select a section data structure of the procedure data structure 210 or the job data structure 250 represented in the sections list 710 to command the server application 125 to delete the selected section data structure from the procedure data structure 210 or the job data structure 250 in the process safety management database 200. This type of command may be disallowed for a scribe role and for a viewer role.

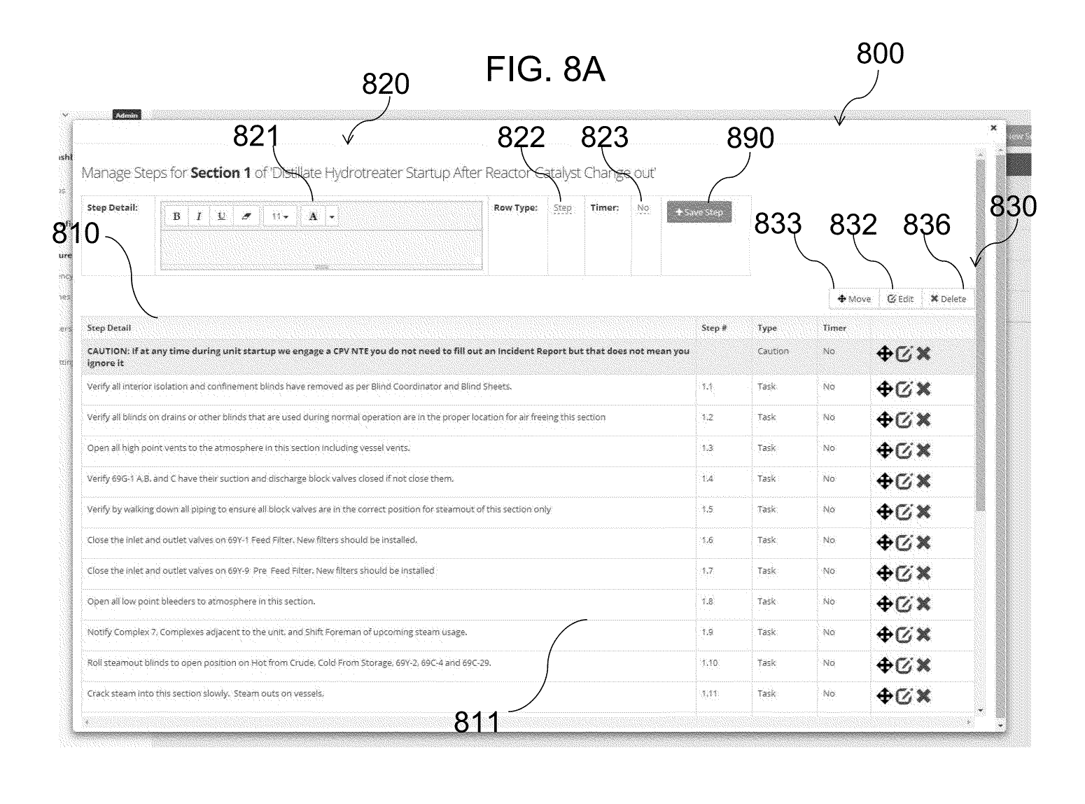

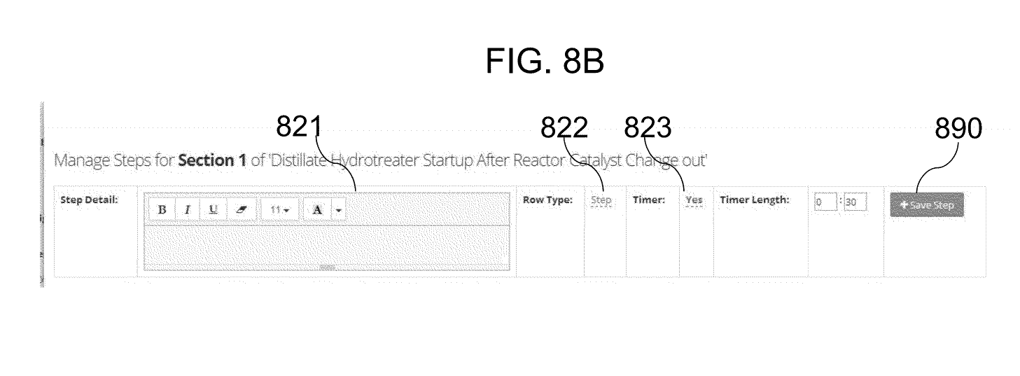

FIGS. 8A and 8B illustrate a steps management user interface 800 which a server application 125 may transmit to the client computer 130. The steps management user interface 800 includes a steps list 810, a step edit panel 820, and a control panel 830, where the step edit panel 820 includes a step edit field 821, a step type toggle 822, a step timer toggle 823, and a step save control 890, and the control panel 830 includes an edit control 832, a move control 833, and a delete control 836.

A steps list 810 may be a representation of each step data structure of a section data structure of a procedure data structure 210 or a job data structure 250 stored in a process safety management database 200. To represent each step data structure, a steps list 810 may display a list item 811. A list item 811 may display the step description element, the step number element, the step type element, and the timer enablement element of the step data structure, and a copy of the control panel 830.

A personnel member may use the input device 120 to input data into the step edit field 821. Data entered into the step edit field 821 may provide information for a human reader regarding the performance of a step of a procedure 300. For example, data entered into the step edit field 821 may describe how to perform a step of a procedure 300.

A personnel member may use the input device 120 to toggle the step type toggle 822 or the step timer toggle 823. The step type toggle 822 may toggle between several different possible values for the step type element of the step data structure, such as a “step” value or a “caution” value. The step timer toggle 823 may toggle between several different possible values for the timer enablement element of the step data structure, such as a “yes” value or a “no” value.

A personnel member may use the step save control 890 to submit data entered into the step edit field 821 to the server application 125. The server application 125 may update data elements of the step data structure of a section data structure of a procedure data structure 210 or a job data structure 250 in accordance with corresponding data submitted from the step edit field 821, the step type toggle 822, and the step timer toggle 823.

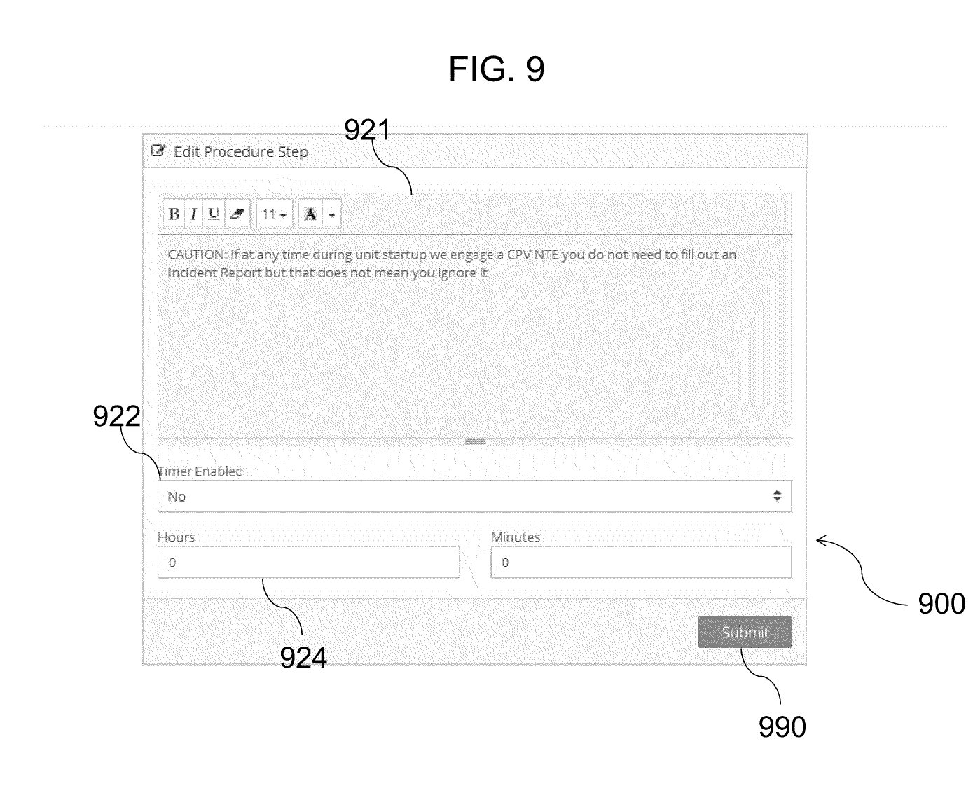

A personnel member may interact with an edit control 832 to select a step data structure represented in the steps list 810 to request a step edit panel 820 to be displayed in a step editing user interface 900 of FIG. 9 displaying elements of the selected step data structure. This type of command may be disallowed for a viewer role.

A personnel member may interact with a move control 833 to select a list item 811 representing a step data structure in the steps list 810 to reorder the list items 811 of the steps list 810. A personnel member may use drag-and-drop interactions to reorder the list items 811. In response to reordering list items 811, the client application 135 may command the server application 125 to update the step number elements of each step data structure in the steps list 810 such that the step number elements indicate the reordered ordering of the step data structures in the steps list 810. This type of command may be disallowed for a viewer role.

A personnel member may interact with a delete control 836 to select a step data structure represented in the steps list 810 to command the server application 125 to delete the selected step data structure from the process safety management database 200. This type of command may be disallowed for a scribe role and for a viewer role.

FIG. 9 illustrates a step editing user interface 900 which a server application 125 may transmit to the client computer 130. The steps editing user interface 900 includes a step description edit field 921, a step timer enablement toggle 922, step timer edit fields 924, and a step submit control 990.

A personnel member may use the input device 120 to input data into the step description edit field 921 or the step timer edit fields 924. Data entered into the step description edit field 921 may provide information for a human reader regarding the performance of a step of a procedure 300. For example, data entered into the step description edit field 921 may describe how to perform a step of a procedure 300. Data entered into the step timer edit fields 924 may provide updated values for a timer hours element and a timer minutes element of the step data structure.

A personnel member may use the input device 120 to toggle the step timer enablement toggle 922. The step timer enablement toggle 922 may toggle between several different possible values for the timer enablement element of the step data structure, such as a “yes” value or a “no” value.

A personnel member may use the step submit control 990 to submit data entered into the step description edit field 921 and the step timer edit fields 924 to the server application 125. The server application 125 may update data elements of the step data structure of a section data structure of a procedure data structure 210 or a job data structure 250 in accordance with corresponding data submitted from the step description edit field 921, the step timer enablement toggle 922, and the step timer edit fields 924.

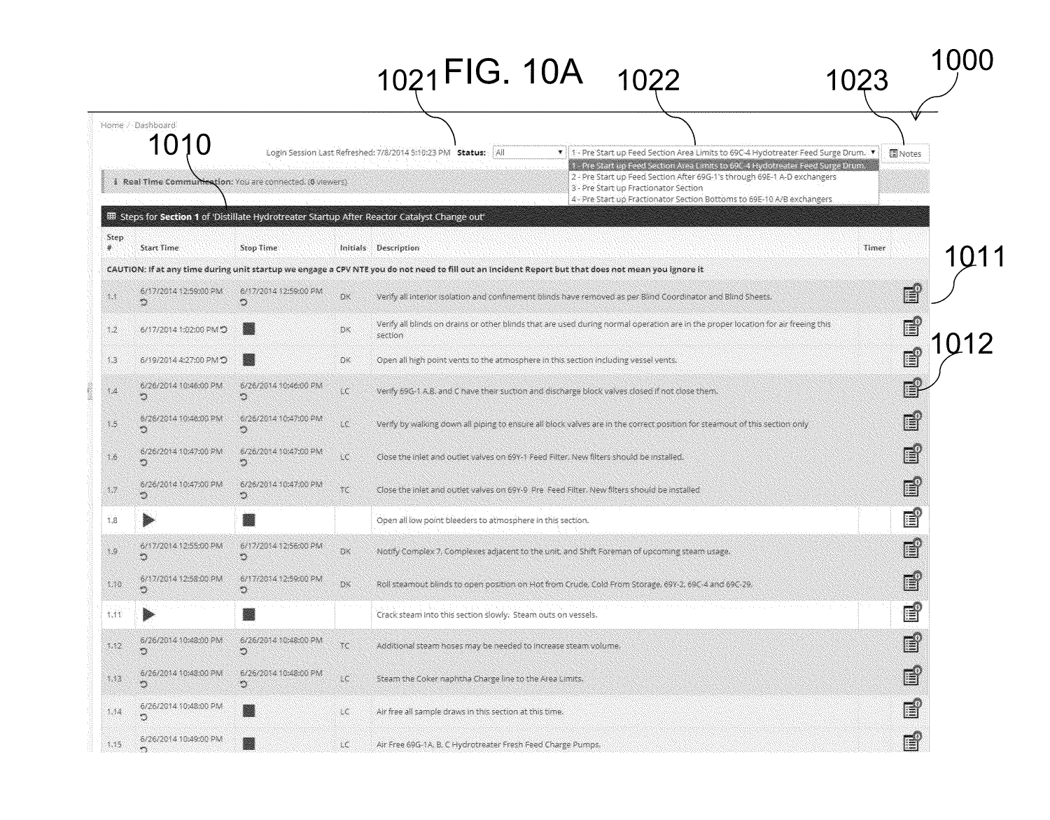

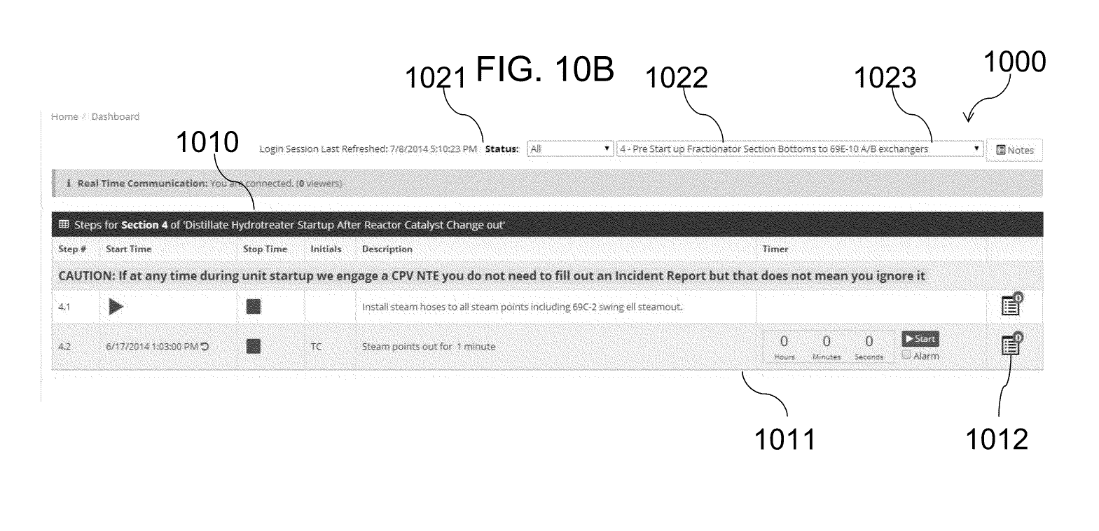

FIGS. 10A and 10B illustrate a steps tracking user interface 1000 which a server application 125 may transmit to the client computer 130. The steps tracking user interface 1000 includes a job steps list 1010, a status filter selector 1021, a section filter selector 1022, and a notes control 1023.

A job steps list 1010 may be a representation of each step data structure of a section data structure of a job data structure 250 stored in a process safety management database 200. To represent each step data structure, a job steps list 1010 may display a list item 1011. A list item 1011 may display the step number element, the start timestamp element, the stop timestamp element, the personnel initials element, the step description element, the timer hours element, and the timer minutes element of the step data structure; a color representing the step status element; and a step notes edit control 1012.

Each of a start timestamp element and a stop timestamp element may contain a time value. While a start timestamp element of a step data structure does not contain a time value, instead of displaying the start timestamp element, a list item 1011 for the step data structure may display a start control. While a stop timestamp element of a step data structure does not contain a time value, instead of displaying the stop timestamp element, a list item 1011 for the step data structure may display a stop control. A personnel member may interact with a start control of a list item 1011 for a step data structure to command the server application 125 to record a time value in the start timestamp element of the step data structure. A personnel member may interact with a stop control of a list item 1011 for a step data structure to command the server application to record a time value in the stop timestamp element of the step data structure. When a time value is recorded in the start timestamp element of a step data structure, the server application 125 may command a client application 135 running on each client computer 130 accessing the server 120 to refresh the display of the steps tracking user interface 1000 to update the list item 1011 for the step data structure to display the start timestamp element. When a time value is recorded in the stop timestamp element of a step data structure, the server application 125 may command a client application 135 running on each client computer 130 accessing the server 120 to refresh the display of the steps tracking user interface 1000 to update the list item 1011 for the step data structure to display the stop timestamp element.

A personnel initials element may contain an initials value or not contain an initials value.

A timer enablement element may contain a “no” value or a “yes” value. A timer hours element may contain an hours value. A timer minutes element may contain a minutes value. If the timer enablement element of a step data structure contains a “no” value, a list item 1011 for the step data structure may not display a timer hours element and may not display a timer minutes element. If the timer enablement element of a step data structure contains a “yes” value, a list item 1011 for the step data structure may display a timer hours element, a timer minutes element, a timer start control, and an alarm control.

If the timer enablement element of a step data structure contains a “yes” value, a personnel member may interact with a timer start control of a list item 1011 for a step data structure to command the client application 135 to run a timer. The timer may count down from the hour value stored in the timer hours element and from the minute value stored in the timer minutes element of the step data structure. A personnel member may interact with an alarm control of a list item 1011 for a step data structure to command the client application 135 to activate an alarm function for a timer. An alarm function for a timer may cause the audio output 134 of the client computer 130 to output a sound upon the timer elapsing. While the client application 135 is running a timer, the server application 125 may command a client application 135 running on each client computer 130 accessing the server 120 to refresh the display of the steps tracking user interface 1000 to update the list item 1011 for the step data structure in real-time to display the hours, minutes, and seconds remaining in the timer.

A personnel member may interact with a step notes edit control 1012 to request a job step notes user interface 1100 to be transmitted to the client computer 130.

A list item 1011 for a step data structure may display a color among several possible colors, where each possible color corresponds to a possible progress status of the step progress status element of the step data structure.

A personnel member may interact with a status filter selector 1021 to select a status filter. The status filter may be a status among several possible progress statuses, such as a “not started” status, an “in progress” status, or a “finished” status. Selecting a status filter may command the server application 125 to query the process safety management database 200 for a status-filtered list of section data structures of a job data structure 250, containing each section data structure having a progress status element having a status that matches the status of the status filter. The client application 135 may then populate the section filter selector 1022 with the section title elements of the status-filtered list of section data structures.

While a status filter is selected from a status filter selector 1021, a personnel member may interact with a section filter selector 1022 to select a section filter. Each section filter may be a section title element of a section data structure of a job data structure 250. Selecting a section filter may command the server application 125 to query the process safety management database 200 for the steps of the section data structure identified by the section filter, a job steps list 1010 to be transmitted to the client computer displaying elements of the status-filtered list of step data structures.

The server application 135 may update the job progress status element of the job data structure 250 in accordance with the step progress status elements of the step data structures of the job data structure 250. When the step progress status element of at least one step data structure of a step type of the job data structure 250 has an “in progress” status or a “finished” status, the server application 125 may update the job progress status element of the job data structure 250 to an “in progress” status. When the step progress status element of each step data structure of a step type of the job data structure has a “finished” status, the server application 125 may update the job progress status element of the job data structure 250 to a “finished” status.

A job data structure 250 where the job progress status element has a “finished” status may be retrieved from the server 120 as an electronic document. An electronic document may, for example, be a Portable Document Format file. An electronic document may be certified by an authorized personnel member in compliance with OSHA regulations.

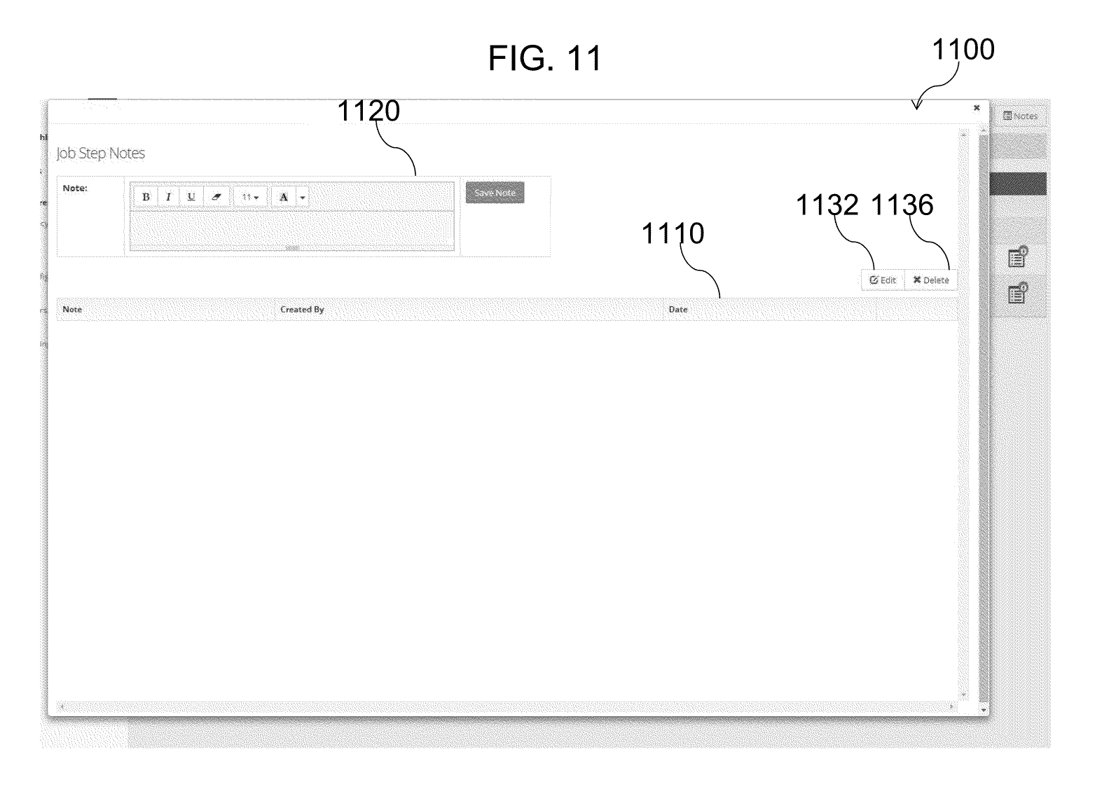

FIG. 11 illustrates a job step notes user interface 1100 which a server application 125 may transmit to the client computer 130. The job step notes user interface 1100 includes a job step notes list 1110, a job step notes creation control 1120, an edit control 1132, and a delete control 1136.

A job step notes list 1110 may be a representation of each note data structure associated with a step data structure of a section data structure of a job data structure 250 stored in a process safety management database 200. To represent each note data structure, a job step notes list 1110 may display a list item. A list item may display the note contents element, the note creator element, and the note creation date element of the note data structure.

A personnel member may use the input device 120 to input data into the job step notes creation control 1120 and to submit data entered into the job step notes creation control 1120 to the server application 125. The server application 125 may create a note data structure of a section data structure of a procedure data structure 210 having a note contents element in accordance with corresponding data submitted from the job step notes creation control 1120; having a note creator element in accordance with the user account of the personnel member; and having a note creation date element in accordance with the date of submission. Data entered into the job step notes creation control 1120 may provide information for a human reader regarding performance deviations from descriptions stored in the step description element of the corresponding step data structure to a step of a procedure 300 during the performance of that step.

A personnel member may interact with a delete control 1136 to select a step data structure represented in the job step notes list 1110 to command the server application 125 to delete the selected note data structure from the process safety management database 200. This type of command may be disallowed for a scribe role and for a viewer role.

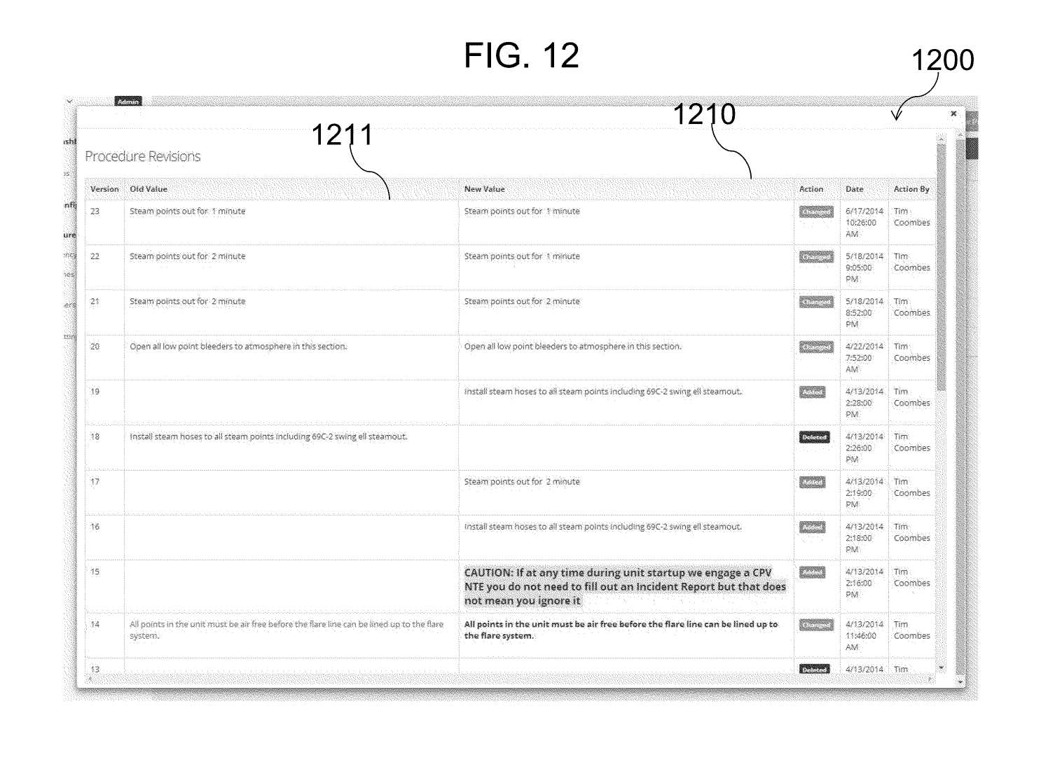

FIG. 12 illustrates a procedure revisions user interface 1200 which a server application 125 may transmit to the client computer 130. The procedure revisions user interface 1200 includes a procedure revisions list 1210.

A procedure revisions list 1210 may be a representation of each procedure revision data structure associated with a procedure data structure 210 stored in a process safety management database 200. To represent each procedure revision data structure, a procedure revisions list 1210 may display a list item 1211. A list item 1211 may display the version number element, the pre-revision value element, the post-revision value element, the revision action element, the revision date element, and the revision actor element. The list items of the procedure revisions list 1210 may be arranged according to the order of the values of the version number element.

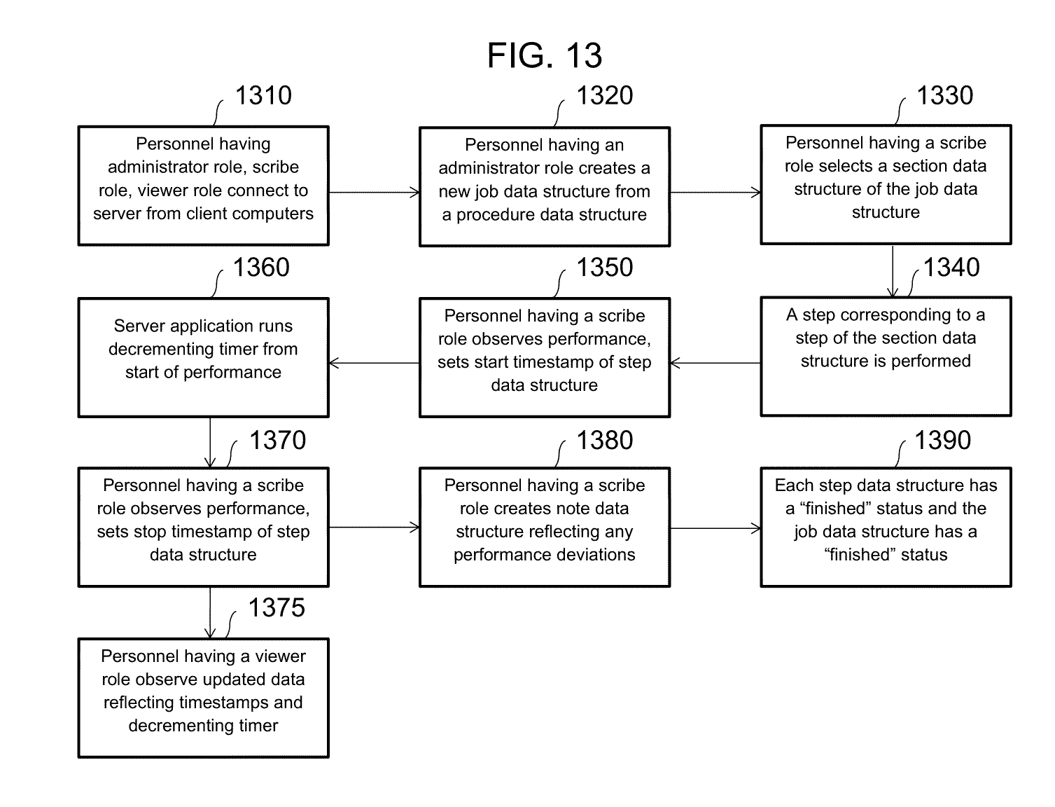

FIG. 13 illustrates a flow diagram of a process safety management method 1300 according to embodiments of the present invention. In a first step 1310 of the process safety management method 1300, a personnel member having an administrator role, a personnel member having a scribe role, and a personnel member having a viewer role each accesses the server 120 from a client computer 130 running the client application 135 by entering authentication credentials into the client application 135 using the input device 132 to identify each personnel member to the client application 135.

In a next step 1320 of the process safety management method 1300, the personnel member having an administrator role accesses the procedure list user interface 400 and interacts with a job creation control 431 to select a procedure data structure 210 represented in the procedure list 410 to command the server application 125 to create a new job data structure 250 containing a copy of the procedure data structure 210. The job progress status element of the new job data structure 250 has a “not started” status.

In a next step 1330 of the process safety management method 1300, the personnel member having a scribe role accesses the job list user interface 600 and interacts with a job view control 631 to select a job data structure represented in the job list 610 to command the server application 125 to request a section list user interface 700 to be transmitted to the client computer 130 displaying elements of the job data structure. The personnel member having a scribe role then accesses the section list user interface 700 and interacts with a steps view control 733 to select a section data structure represented in the job list 610 to command the server application 125 to request a steps tracking user interface 1000 to be transmitted to the client computer 130 displaying elements of the selected section data structure. The selected section data structure may be the section data structure having the smallest section number element value and including a step data element having a step progress status element of “not started.”

In a next step 1340 of the process safety management method 1300, the personnel member having a scribe role accesses the steps tracking user interface 1000 and interacts with a section filter selector 1022 to select a section filter to command the server application 125 to query the process safety management database 200 for the steps of the section data structure identified by the section filter, and to transmit a job steps list 1010 to the client computer displaying elements of the list of step data structures. A step of a procedure, where the step correlates to a step data structure of the list of step data structures, is performed. The step may be performed by one or more personnel members having a scribe role.

In a next step 1350 of the process safety management method 1300, upon the start of the performance of the step, the personnel member having a scribe role interacts with the start control of the list item 1011 for the step data structure to command the server application to record a time value in the start timestamp element of the step data structure.

In a next step 1360 of the process safety management method 1300, if the timer enablement element of a step data structure contains a “yes” value, the client application 135 runs a timer counting down from the hour value stored in the timer hours element and from the minute value stored in the timer minutes element of the step data structure.

In a next step 1370 of the process safety management method 1300, a personnel member interacts with the stop control of the list item 1011 for the step data structure to command the server application 125 to record a time value in the stop timestamp element of the step data structure. The server application 125 updates the status of the step progress status element of the step data structure to “finished.”

In a step 1370 of the process safety management method 1300 occurring concurrently with steps 1350, 1360, and 1370, when a time value is recorded in the stop timestamp element of a step data structure, the server application 125 commands a client application 135 running on each client computer accessing the server 120 to refresh the display of the steps tracking user interface 1000 to update the list item 1011 for the step data structure to display the start timestamp element. While the client application 135 is running a timer, the server application 125 commands a client application 135 running on each client computer 130 accessing the server 120 to refresh the display of the steps tracking user interface 1000 to update the list item 1011 for the step data structure in real-time to display the hours, minutes, and seconds remaining in the timer. When a time value is recorded in the stop timestamp element of a step data structure, the server application 125 commands a client application 135 running on each client computer 130 accessing the server 120 to refresh the display of the steps tracking user interface 1000 to update the list item 1011 for the step data structure to display the stop timestamp element.

In an optional next step 1380 of the process safety management method 1300, if, while observing the performance of a step, a personnel member having a scribe role observes any performance deviations from descriptions stored in the step description element of the corresponding step data structure, the personnel member having a scribe role interacts with a step notes edit control 1012 to request a job step notes user interface 1100 to be transmitted to the client computer 130, then interacts with a job step notes creation control 1120 of a job step notes user interface 1100 to create a note data structure of a section data structure of a procedure data structure documenting performance deviations.

In a next step 1390 of the process safety management method 1300, when each step progress status element of each step data structure of a job data structure 250 has a status of “finished,” the server application 125 updates the status of the job progress status element of the job data structure 250 to “finished.” The job data structure 250 is written in the process safety management database 200 in a fixed state where it cannot be further modified. The job data structure 250 may be retrieved from the server 120 as an electronic document. The electronic document may be certified.

Another user interface according to embodiments of the present invention may display a graphic representation of time to completion of steps correlating to step data structures having step progress status elements set to “in progress” at a given time.

Another user interface according to embodiments of the present invention may display allocations for personnel members having a viewer role, and re-allocate personnel members in accordance with step data structures having step progress status elements set to “in progress” where a timer has elapsed.

Another user interface according to embodiments of the present invention may display piping and instrumentation diagrams relevant to the performance of a step of a process.

While particular elements, embodiments, and applications of the present invention have been shown and described, the invention is not limited thereto because modifications may be made by those skilled in the art, particularly in light of the foregoing teaching. It is therefore contemplated by the application to cover such modifications and incorporate those features which come within the spirit and scope of the invention.

What is claimed is:

1. A method of creating a compliance record, comprising:
authenticating an administrator role of a first personnel member accessing a server application hosted on a server from a first client computer in communication with the server;
authenticating a scribe role of a second personnel member accessing the server application from a second client computer in communication with the server;
authenticating a viewer role of a third personnel member accessing the server application from a third client computer in communication with the server;
in response to a command from the first client computer, creating a job data structure corresponding to a process, wherein the job data structure is stored on the server storage and includes a job progress status element and at least one step data structure, wherein a step data structure includes a step progress status element;
in response to a command from the second client computer, setting the job progress status element to an in-progress status;
in response to a command from the second client computer while the job progress status element is set to an in-progress status, setting the step progress status element to an in-progress status;
in response to a command from the second client computer while the step progress status element is set to an in-progress status, setting the step progress status element to a finished status;
in response to setting each step progress status element of each step data structure of the job data structure to a finished status, setting the job progress status element to a finished status; and
in response to setting the job progress status element to a finished status, recording the job data structure in a fixed state.

2. The method of claim 1, wherein each of the first client computer, the second client computer, and the third client computer is in a location remote from each other.

3. The method of claim 1, further comprising refreshing a display of one of the first, second, and third client computers in real-time, wherein the refreshed display indicates a change in the job data structure.

4. The method of claim 3, wherein the change in the job data structure is setting the job progress status element to an in-progress status.

5. The method of claim 3, wherein the change in the job data structure is setting the step progress status element to an in-progress status.

6. The method of claim 3, wherein the change in the job data structure is setting the step progress status element to a finished status.

7. The method of claim 3, wherein the change in the job data structure is setting the job progress status element to a finished status.
while the step progress status element is set to an in-progress status, refreshing a display of the third client computer in real-time, wherein the display of the third client computer indicates a timer running while the step progress status element is set to an in-progress status;

8. The method of claim 1, wherein a step data structure further comprises a timer hours element and a timer minutes element; and
further comprising in response to a command from the second client computer, while the job progress status element is set to an in-progress status, running a timer counting down from the value of the timer hours element and the value of the timer minutes element at the second client computer.

9. The method of claim 8, further comprising refreshing a display of one of the first, second, and third client computers in real-time, wherein the refreshed display indicates a change in the timer running at the second client computer.

10. A non-transitory computer-readable medium, comprising:
a process safety management database, the database comprising:
a procedure data structure; and
a job data structure;
wherein the procedure data structure comprises a section data structure;
wherein the section data structure comprises a step data structure;
wherein the job data structure comprises a copy of the procedure data structure; and
wherein the copy of the procedure data structure further comprises a copy of the section data structure of the procedure data structure, and the copy of the section data structure further comprises a copy of the step data structure of the section data structure.

11. The non-transitory computer-readable medium of claim 11, wherein:
the job data structure further comprises a job progress status element; and
the copy of a step data structure further comprises a step progress status element.

12. The non-transitory computer-readable medium of claim 11, wherein each job progress status element is set to a finished status, each step progress status element is set to a finished status, and the job data structure is recorded in a fixed state.

13. The non-transitory computer-readable medium of claim 11, wherein the copy of a step data structure further comprises a timer hours element and a timer minutes element.

14. The non-transitory computer-readable medium of claim 11, wherein the database further comprises a procedure revision data structure associated with a step data structure.
